(19) United States
(12) Patent Application Publication
(10) Pub. No.: US 2026/0237546 A1
(43) Pub. Date: Aug. 13, 2026

(54) Saxophone Resonator Swapping System

(71) Applicant: Michael Borkovic, Montréal (CA)

(72) Inventor: Michael Borkovic, Montréal (CA)

(21) Appl. No.: 19/256,218

(22) Filed: Jul. 1, 2025

(30) Foreign Application Priority Data
Feb. 7, 2025 (WO) PCT/US2025/14904

(51) Int. Cl. H01F 7/02

(52) U.S. Cl. CPC H01F 7/0252

(57) ABSTRACT

A two-part resonator swapping system allows users to freely swap resonators to modify the sound of an instrument, such as a saxophone. The system has a backing magnet that attaches to a bottom side of a pad and a resonator magnet that attaches to the resonator and then magnetically connects to the bottom side of the magnet through a hole in the pad. The backing magnet includes a spud that enters the saxophone pad's hole and a flange that contacts the pad's bottom side. The top side of the flange is at least semi-permanently attached to the pad via an adhesive. The resonator magnet is likewise at least semi-permanently attached to the resonator via an adhesive. Thus, the user can place the resonator, with its resonator magnet, on the top side of the pad, which will cause the resonator magnet to connectibly attract to the backing magnet's spud.

### CROSS-REFERENCES TO RELATED APPLICATIONS

This U.S. Non-Provisional Patent Application claims, via the Paris Convention 35 USC 119, the benefit of and priority to Application No. PCT/US2025/14904, filed Feb. 7, 2025, entitled “Saxophone Resonator Swapping System,” the entire contents of which are hereby incorporated herein by reference.

### BACKGROUND

Current saxophone pads come with or without a resonator riveted or snapped in the center of the pad. These resonators come in many shapes, sizes, finishes and materials, which are sold to customers assuming that these may affect the sound generated by the instrument.

Typically, resonators are permanently fixed and inaccessible without dismounting all the pads and installing new pads in their place in a process called “overhaul.” Overhauling the saxophone can be a relatively expensive, long, and imprecise process. For example, technicians may not overhaul saxophones the same way each time, pad technology may change between overhauls, technicians become unavailable, etc., all of which may prevent users from proper A/B comparison testing of resonators.

### SUMMARY

Implemented is a two-part magnetic system that allows users to freely swap resonators to modify the saxophone's sound. The system employs a strong and heat-resistant neodymium pad backing as the base for the resonator to snap to and a neodymium ring or cylindrical magnet that adheres to the resonator. A backing magnet includes a spud that enters the saxophone pad's hole and a flange that contacts the pad's bottom side. The backing magnet is magnetized to attract a resonator magnet. The top side of the backing magnet's flange is at least semi-permanently attached to the pad via an adhesive. This way, the pad and backing magnet are at least semi-permanently attached. The resonator magnet is likewise at least semi-permanently attached to the resonator via an adhesive. Thus, the user can place the resonator, with its resonator magnet, on the top side of the pad, which will cause the resonator magnet to attract (whether contact is made or not) to the backing magnet's spud. The resonator is thereby freely replaceable and reusable by musicians by lifting the magnetized resonator from the pad and replacing it with another similarly constructed resonator. Different resonators can vary in characteristics, so replacing one resonator with another can affect the instrument's sound.

Thus, users can perform a single overhaul to implement the resonator swapping system, allowing them to freely change the resonators themselves. Even if a player doesn't want swappable resonators, players could audition resonators in stores that choose to offer a demo saxophone with these swappable resonators before making a decision on resonators for their overhaul. Furthermore, resonators become reusable and exchangeable with other players/musicians with the current system.

The saxophone resonator swapping system provides a method for changing resonators with a minimum time between A testing and B testing to save on cost, time, and influence from external sources telling players how they will sound rather than knowing it for themselves. This savings of time and cost can liberate the player to freely experiment with their resonator arrangement in a way that has been cost-prohibitive before, allowing them to refine the core of their instrument's tone.

### BRIEF DESCRIPTION OF THE DRAWINGS

FIG. 1 shows an illustrative exploded representation of a magnetic resonator system components;

FIG. 2 shows an illustrative representation of a saxophone pad's bottom side with a backing magnet attached thereto;

FIG. 3 shows an illustrative representation of the saxophone pad's top side with a resonator thereon;

FIGS. 4A-E show illustrative representations of different resonator magnet designs to accommodate different resonators;

FIG. 5 shows an illustrative representation of the resonator's rivet to which the resonator magnet engages;

FIG. 6 shows an illustrative representation of a sample resonator in use with the magnetic resonator system and a detachable resonator being lifted and removed;

FIG. 7 shows an illustrative representation of the resonator fully removed from the saxophone pad; and

FIG. 8 shows an illustrative representation of a new resonator being removably attached to the saxophone pad for use.

### DETAILED DESCRIPTION

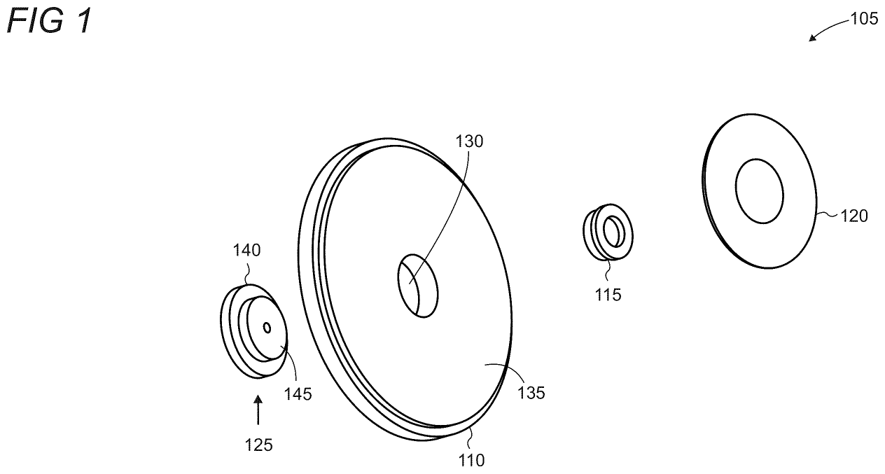

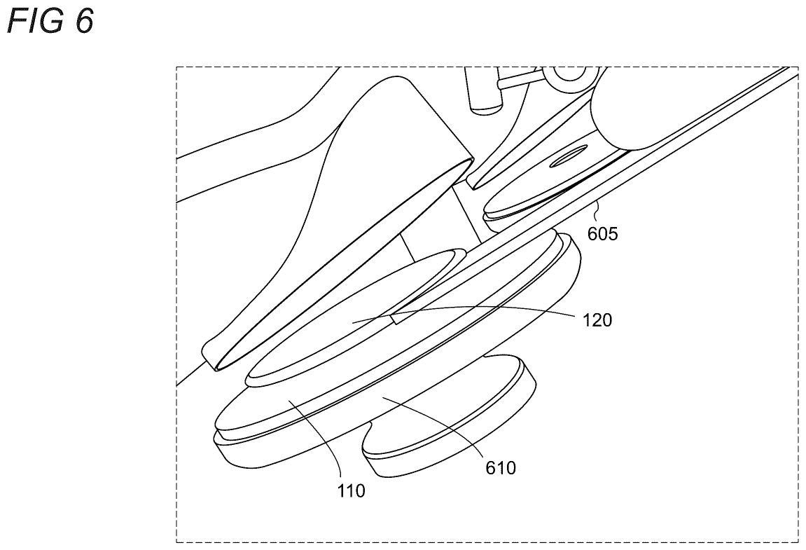

FIG. 1 shows an illustrative exploded representation of a magnetic resonator system 105 in which at least two magnets are used to create an easily replaceable resonator swapping system for saxophones or other musical instruments. The resonator system 105 includes a saxophone pad 110 having a hole 130 therein, a resonator magnet 115 and resonator 120 positioned on the top side of the pad, and a backing magnet 125 positioned on the bottom side of the pad. The pad also includes an exterior layer 135, which, in typical implementations, may be a leather coat that at least partially encapsulates the pad. When fully assembled, the backing magnet's spud 145 extends at least partially into the pad's hole 130 and the flange 140 contacts the pad's bottom surface. Typically, the spud and the flange of the backing magnet are each magnetized, as the flange attracts to the key (FIGS. 6-8) and the backing magnet is used to magnetically attract to the resonator magnet, as discussed in greater detail below. However, in other implementations, the flange may be connected to the key differently, such as with adhesive, such that only the spud is magnetized.

The resonator magnet 115 enters the opposite top side of the pad's hole, causing the respective magnets to attract. The resonator magnet is attached to the resonator's surface, such as with an adhesive, so that the resonator magnet and resonator are essentially permanently attached. As discussed in greater detail below, the resonator magnet may engage, such as encapsulate, a rivet extending from the resonator's bottom surface so the resonator magnet may be adhesively attached to the rivet. The backing magnet spud 145 and resonator magnet are each sized to correspond with the pad's hole such that the magnet's substantially contact with the hole's interior perimeter.

The backing magnet's spud 145 and resonator magnet 115 may enter any distance within the pad's hole 130, and they may enter the same distance or different distances. For example, the spud and resonator magnet may each extend halfway through the hole; they may be aligned with the pad's exterior surfaces such that the magnets do not enter the holes, the magnets (backing magnet's spud and resonator magnet) may extend fully through the pad's hole or any combination thereof. The size and extension of the spud and resonator magnet may vary based on the specific implementation, which may affect the strength of the magnetic attraction, the permanency and security of the resonator system when deployed, the output sound of the instrument, etc.

The backing magnet 125 is made of heat-resistant neodymium. In typical implementations, the backing magnet leverages an N42SH grade magnet, but other magnets that withstand higher or lower temperatures or higher or lower magnetism that can perform the functions herein are also possible. The magnet is configured to resist the heat that is necessarily applied to the magnet during a standard overhaul. The N42SH is resistant to temperatures that would be damaging to the finish of a saxophone. The option for lowering magnetism could be relevant to using steel tools during repair and improved balancing of magnetism if the player finds the resonator difficult to remove and would prefer a more comfortable experience.

The thickness of the backing magnet 125 helps prevent interference with the pad's proper seating and function. In typical implementations, the thickness of the backing magnet may be less than the thickness of the leather excess on the back of the pad and the thickness of the shellac or glue that holds the pad in place. Thus, the backing magnet may sit slightly above the leather but not above the leather and adhesive shellac layer.

The thickness of the backing magnet's spud allows a small air gap between the backing magnet and the resonator. The air gap prevents sympathetic vibrations and hard mechanics noise from the closing of the saxophone keys during playing. This adds additional insurance that the resonator is sealing hard against the pad and not being held off of the pad's front surface. This thickness varies based on the thickness of the pad and may range from 0-6 mm or more, depending on the specific implementation. Similarly, the resonator magnet has a thickness for the reasons listed above, such as the air gap, sympathetic vibrations, mechanical noise, etc.

In typical implementations, the resonator magnet is comprised of N52 magnets since these won't have to be exposed to high heat during an overhaul or repair. The resonator magnet is also naturally further from the heat source and, therefore, not exposed to the same amount of heat as the backing magnet. While neodymium magnets are discussed herein, other types of magnets may also be used, even without the heat-sensitivity property.

The diameter of the backing and resonator magnets depends on the pad's diameter. Relatively small pads may be center punched at around 6 mm and can receive a backing magnet with a 6 mm “spud.” The resonator magnet will accept a resonator using a 6 mm resonator backing. Larger pads may use an 8 mm diameter version. The “flange” of each pad is 4 mm larger in diameter than its spud. While certain sizes are disclosed herein, other sizes and variations are also possible. In particular, any magnet or high carbon steel or iron design that utilizes a spud and flange, regardless of size, may be used to effectuate the saxophone resonator swapping system.

The backing magnet is shaped to maximize magnetism with the largest volume with an integrated backing to prevent the magnet from pulling through the hole in the pad. This could be achieved with an integrated magnet, or a magnet mated to a material that acts as a flange. Typically, the more ferrous the material, the better, as it improves the magnetism to the resonator.

The resonator magnet comes in a ring format to adapt a technician's current resonator stock to the magnetic style without purchasing new, modified stock. The ring's inside diameter can range from 3-4 mm, and the outside ranges from 6-8 mm, but other variations are also possible.

In other embodiments, resonators may come with tapered magnets without the hollow center and pre-installed to offer more strength for the player directly or the technician who does not want to perform the modifications on resonators themselves. Non-hollow magnets have the advantage of more mass (therefore more magnetism) since the magnet's center is not empty.

The tapered resonator magnet is tapered to allow smooth entry into the hole without allowing the resonator to slip under the pad leather. This may be superior to implementations that utilize a metal eyelet for the reasons above regarding air gap, sympathetic vibrations, and mechanical noise, but also in that the eyelet would add unwanted variables to the resonator, such as extra height, restriction of smallest diameter resonators that can be used, and prevention of resonator sealing well against pad leather. While various sizes and dimensions are provided above, such sizes and dimensions are exemplary only for typical implementations, but larger or smaller size variations and variations in shapes are possible as well to effectuate the purposes herein.

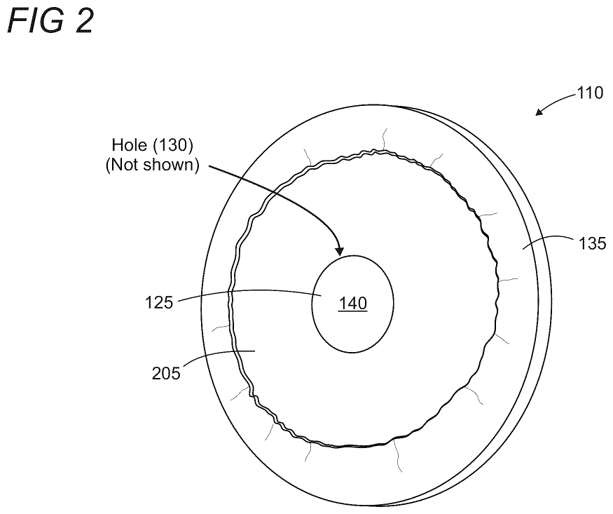

FIG. 2 shows an illustrative representation of the backing magnet 125 attached to the pad's bottom side. The pad's exterior layer 135 extends from the front side of the pad and then only covers a portion of the bottom side. The pad's construction, in typical implementations, may be an interior layer (not shown) comprised of a mesh or felt material, a middle layer 205, which may be, for example, a cardboard layer that is placed on the bottom side of the interior layer, and then the exterior layer that covers the top side of the pad and then a portion of the bottom side. The exterior layer may be securely attached to the pad via an adhesive against the middle layer to prevent the exterior coat from movement or removal.

The backing magnet's spud 145 is engaged within the pad's hole 130 (not shown in FIG. 2), and the back side of the flange 140 is exposed. The backing magnet's flange is flat and is primarily employed to prevent the backing magnet from fully extending through the pad's hole. This way, the flange contacts the pad's bottom side, namely the middle layer, and holds the magnet in place. The flange may be at least semi-permanently attached to the magnet's bottom side via an adhesive since the primary component to be changed is the resonator 120—not the backing magnet. The backing magnet 125 serves as the static base that attracts the resonator's magnet 115 for a sturdy connection via magnetism while also enabling easy replacement of the resonator.

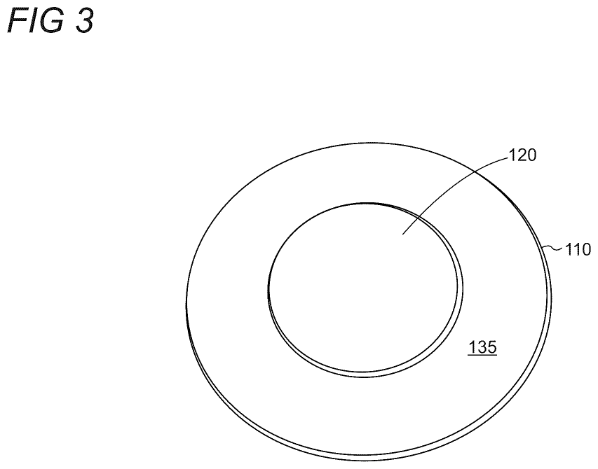

FIG. 3 shows an illustrative representation in which the resonator 120 is placed on top of the pad 110. Although not shown, the resonator magnet 115 is secured to the resonator's bottom side via, for example, an adhesive. Thus, once the resonator is positioned on top of the pad 110 and near the pad's hole 135, the resonator magnet 115 attracts to the backing magnet, which is already semi-permanently or permanently attached to the pad's bottom side and the backing magnet's spud 145 is already aligned with the pad's bottom side hole or extending at least partially therein. The attraction of the magnets will align and center the resonator, and the resonator magnet will align with the pad's top side hole or extend at least partially through the hole.

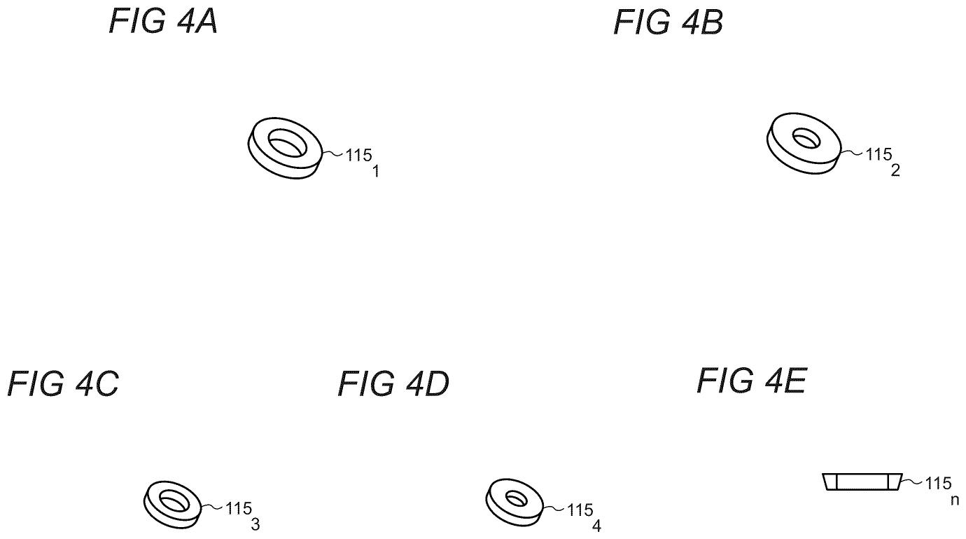

FIGS. 4A-E show illustrative representations in which a resonator magnet 115 has various configurations to accommodate different resonators 120. Many resonators include some rivet that extends from its bottom side. Thus, the resonator magnets include a recess or throughole to accommodate and receive the rivet while still attaching to the resonator. In this regard, the resonator magnet may form a cylindrical shape with a throughole in the middle that extends partially or fully through its other side. Other openings, indents, or throughole types are also possible depending on the specific rivet for a given resonator, as shown in the various examples in FIG. 4. In FIG. 4C, an indent extends around the periphery of a center body, as some resonators may have a circular-type rivet or protrusion. FIG. 4E shows an exemplary embodiment in which the resonator magnet can be tapered.

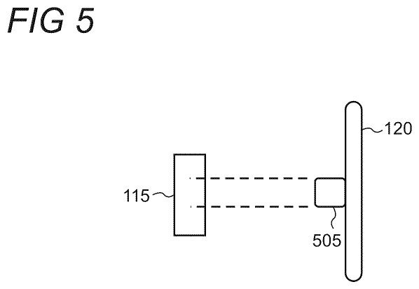

FIG. 5 shows an illustrative representation in which the resonator 120 includes a rivet 505 extending from its bottom surface. Since many resonators are adapted with a rivet, the resonator magnet 115 has been configured with a cylindrical body and a throughhole within its body, typically at its center, such that its hole is adapted to fit around the resonator's rivet. Typically, the length and width of the resonator magnet's hole may correspond to the size and shape of the rivet such that when the resonator magnet is positioned around the rivet, the end of the rivet corresponds and aligns with the resonator magnet's end. Also, the resonator magnet's body may have a length that corresponds to the rivet's length, such that the rivet typically will not extend beyond the resonator magnet's body. However, in some implementations, the length of the resonator magnet's body may be shorter or longer than the length of the rivet. Different resonator magnet sizes, shapes, indents, and througholes can accommodate various resonator sizes, shapes, surfaces, and rivets. In some situations, the resonator's rivet may be cut before attaching and securing, such as with adhesive, the resonator magnet to the resonator, such as if the rivet is too long and may interfere with the system. Thus, in at least some situations, the rivet may be custom-built or designed to operate effectively with the present system.

FIG. 6 shows an illustrative representation in which the pad 110 is laid against a key 610 within the saxophone. Each key may be similarly configured with the saxophone pad. Here, the backing magnet 125 (not shown) is attached to the pad's rear. The rear side of the backing magnet's flange 125 maintains the backing magnet's position relative to the front of the pad, providing more mass and therefore more magnetism, and providing a surface to bond with adhesive.

In FIG. 6, a user is shown using a tool 605 to lift the resonator 120 engaged with the pad. The tool may be necessary, for example, since the resonator magnet 115 (not shown) attracts the backing magnet, thereby creating a magnetic force that requires some strength to break. Since the resonator magnet is attached to the bottom side of the resonator via, for example, an adhesive, the resonator lifts with the resonator magnet.

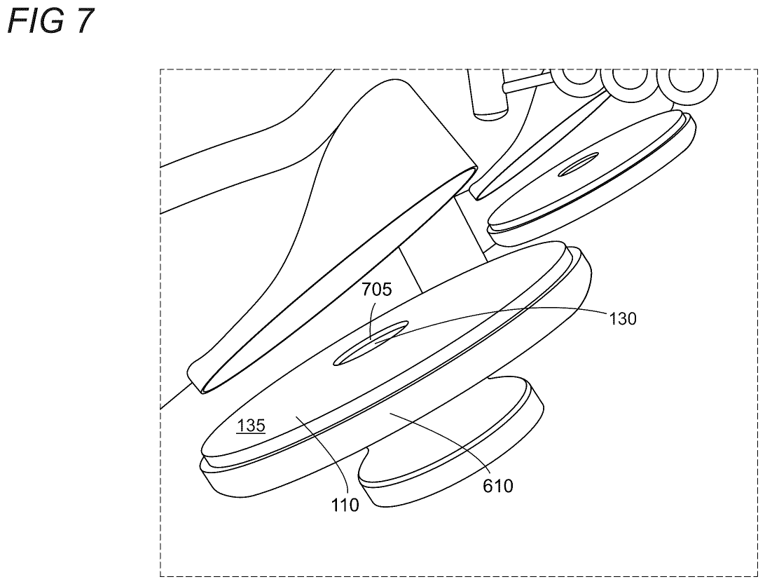

FIG. 7 shows an illustrative representation in which the resonator 120 has been lifted, thereby exposing saxophone pad 110. As shown, the pad's hole 130 is exposed, along with a portion of the interior layer 705, which is covered by the exterior layer 135. Once the resonator is removed, the user is free to replace it with alternate resonators of different sizes that can affect the instrument's output sound.

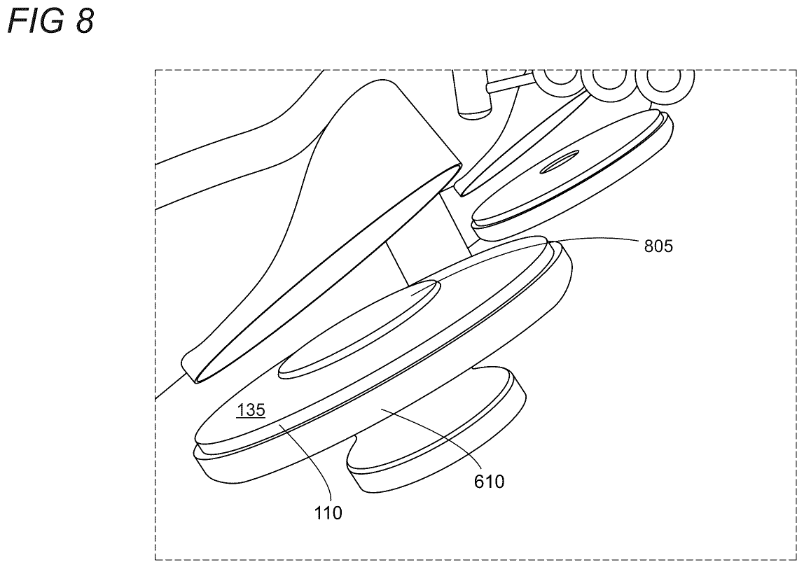

FIG. 8 shows an illustrative representation in which a new resonator 805 has been placed on top of the pad 110. The new resonator is similarly configured with a resonator magnet 115 on its bottom side (not shown), which aligns with and may at least partially enter the pad's hole 130 and magnetically attracts to the backing magnet's spud. Contact between the resonator and backing magnets is possible, but not necessary, as the magnetic attraction alone may be sufficient to lock the components in place. The user is now free to test their instrument with the new resonator on that specific key and do some A/B comparison testing among resonators. The user can easily continue doing so or change their instrument's sound among a plurality of different resonators. For example, resonators can be comprised of various materials, sizes, and shapes. Resonators may be flat or domed, ranging from small to large diameters, which affects how much pad coverage occurs; materials can include metal (brass, stainless steel, aluminum), plastic or synthetic, or a hybrid design of a variety of components. Various resonator designs affect the instrument's overall sound, such as projection, warmth, volume, etc.

Various exemplary embodiments have been disclosed herein. In one exemplary embodiment, implemented is a resonator swapping system, comprising: a backing magnet; a pad having a hole therein, wherein at least a portion of the backing magnet extends at least partially through the pad's hole; a resonator magnet; and a resonator attached to the resonator magnet, wherein the resonator magnet and the backing magnet attract and cause the resonator and pad to contact each other.

As another example, the backing magnet extends at least partially through the pad's hole on a first side of the pad. In another example, the resonator magnet extends at least partially through the pad's hole on a second side thereof. In another example, a flange on the backing magnet. As another example, the flange contacts an underside of the pad, and the flange is semi-permanently attached to the pad via an adhesive. As a further example, the pad is comprised of: an interior layer; a middle layer that at least partially encapsulates the interior layer; and an exterior layer that at least partially encapsulates the middle layer. In another example, the flange of the backing magnet is attached to the pad's exterior layer. As another example, an underside of the resonator includes a protrusion. In another example, the resonator magnet is positioned around a perimeter of the resonator's protrusion, such that the resonator magnet includes an opening inside which the protrusion enters. As another example, the resonator magnet is attached to the resonator with an adhesive.

In another exemplary embodiment, disclosed is a method of assembling a replaceable resonator for a musical instrument, comprising: providing a pad having a hole therein, wherein at least a portion of the backing magnet extends at least partially through the pad's hole; attaching a backing magnet to the pad; attaching a resonator magnet to a resonator; providing the resonator adjacent to the pad, wherein the resonator magnet and the backing magnet attract and cause the resonator and pad to contact each other.

In another example, the backing magnet extends at least partially through the pad's hole on a first side of the pad. As another example, the resonator magnet extends at least partially through the pad's hole on a second side thereof. In a further example, a flange on the backing magnet. As another example, the flange contacts an underside of the pad, and the flange is semi-permanently attached to the pad via an adhesive. In another example, the pad is comprised of: an interior layer; a middle layer that at least partially encapsulates the interior layer; and an exterior layer that at least partially encapsulates the middle layer. In another example, the flange of the backing magnet is attached to the pad's exterior layer. As another example, an underside of the resonator includes a protrusion. As another example, the resonator magnet is positioned around a perimeter of the resonator's protrusion, such that the resonator magnet includes an opening inside which the protrusion enters. In another example, the resonator magnet is attached to the resonator with an adhesive.

1. A resonator swapping system, comprising:
a backing magnet;
a pad having a hole therein, wherein at least a portion of the backing magnet extends at least partially through the pad's hole;
a resonator magnet; and
a resonator attached to the resonator magnet, wherein the resonator magnet and the backing magnet attract and cause the resonator and pad to contact each other.

2. The resonator swapping system of claim 1, wherein the backing magnet extends at least partially through the pad's hole on a first side of the pad.

3. The resonator swapping system of claim 1, wherein the resonator magnet extends at least partially through the pad's hole on a second side thereof.

4. The resonator swapping system of claim 1, further comprising a flange on the backing magnet.

5. The resonator swapping system of claim 4, wherein the flange contacts an underside of the pad, and the flange is semi-permanently attached to the pad via an adhesive.

6. The resonator swapping system of claim 5, wherein the pad is comprised of:
an interior layer;
a middle layer that at least partially encapsulates the interior layer; and
an exterior layer that at least partially encapsulates the middle layer.

7. The resonator swapping system of claim 6, wherein the flange of the backing magnet is attached to the pad's exterior layer.

8. The resonator swapping system of claim 1, wherein an underside of the resonator includes a protrusion.

9. The resonator swapping system of claim 8, wherein the resonator magnet is positioned around a perimeter of the resonator's protrusion, such that the resonator magnet includes an opening inside which the protrusion enters.

10. The resonator swapping system of claim 9, wherein the resonator magnet is attached to the resonator with an adhesive.

11. A method of assembling a replaceable resonator for a musical instrument, comprising:
providing a pad having a hole therein, wherein at least a portion of the backing magnet extends at least partially through the pad's hole;
attaching a backing magnet to the pad;
attaching a resonator magnet to a resonator;
providing the resonator adjacent to the pad,
wherein the resonator magnet and the backing magnet attract and cause the resonator and pad to contact each other.

12. The method of claim 11, wherein the backing magnet extends at least partially through the pad's hole on a first side of the pad.

13. The method of claim 11, wherein the resonator magnet extends at least partially through the pad's hole on a second side thereof.

14. The method of claim 11, further comprising a flange on the backing magnet.

15. The method of claim 14, wherein the flange contacts an underside of the pad, and the flange is semi-permanently attached to the pad via an adhesive.

16. The method of claim 15, wherein the pad is comprised of:
an interior layer;
a middle layer that at least partially encapsulates the interior layer; and
an exterior layer that at least partially encapsulates the middle layer.

17. The method of claim 16, wherein the flange of the backing magnet is attached to the pad's exterior layer.

18. The method of claim 11, wherein an underside of the resonator includes a protrusion.

19. The method of claim 18, wherein the resonator magnet is positioned around a perimeter of the resonator's protrusion, such that the resonator magnet includes an opening inside which the protrusion enters.

20. The method of claim 19, wherein the resonator magnet is attached to the resonator with an adhesive.
